(19) United States
(12) Patent Application Publication
(10) Pub. No.: US 2005/0236997 A1
(43) Pub. Date: Oct. 27, 2005

(54) Dielectric barrier discharge lamp having outer electrodes and illumination system having this lamp

(75) Inventors: Walter Danner, Herbrechtingen (DE); Gerhard Doll, Guangzhou (CN)

Correspondence Address: OSRAM SYLVANIA INC, 100 ENDICOTT STREET, DANVERS, MA, 01923, US

(73) Assignee: PATENT-TREUHAND-GESELLSCHAFT FUR ELEKTRISCHE GLUHLAMPEN MBH, Munchen (DE)

(21) Appl. No.: 11/109,827

(22) Filed: Apr. 20, 2005

(30) Foreign Application Priority Data
Apr. 23, 2004 (DE) 102004020398.9

(51) Int. Cl. H01J 17/16; H01J 61/30

(52) U.S. Cl. 313/634

(57) ABSTRACT

In the case of a dielectric barrier discharge lamp, the discharge vessel (1) is composed of an outer bulb (3) and an inner bulb (4) arranged within the outer bulb, with the result that a discharge space (8) filled with a discharge medium is formed between the inner and the outer bulb. Strip-like electrodes (11) are arranged on the outer side, which is remote from the discharge medium, of the wall of the inner bulb (4). Since there are no longer inner electrodes having a dielectric coating and there is no gas-tight current bushing, this concept combines simple manufacture with protection of the outer electrodes, for example against electric shock.

### TECHNICAL FIELD

The invention is based on a dielectric barrier discharge lamp.

With this type of lamp, the electrodes are separated from the discharge medium found in the interior of the discharge vessel by a dielectric. In this case, the electrodes may in principle either all be arranged within, all outside, or the electrode(s) of one polarity within and the other(s) outside of the discharge vessel. For electrodes arranged outside of the discharge vessels (also referred to below as outer electrodes), the wall of the discharge vessel acts as a dielectric barrier. If all of the electrodes are arranged within the discharge vessel (also referred to below as inner electrodes), however, at least one electrode or the electrodes of one polarity must be separated from the interior of the discharge vessel by a dielectric, for example by a dielectric coating. This dielectric barrier means that there is a so-called discharge which is dielectrically impeded on one side during operation. Alternatively, all of the inner electrodes may also be provided with a dielectric coating. This is a discharge which is dielectrically impeded on both sides. The latter also applies in particular to the case of interest here in which all of the electrodes are arranged outside of the discharge vessel.

In dielectric barrier discharge lamps, the dielectrically impeded gas discharge produces radiation powers in the UV (ultraviolet) range, including the so-called VUV (vacuum ultraviolet) range (having wavelengths below 200 nm), which are converted into radiation powers in the visible range in the case of lamps for lighting applications using fluorescent materials or fluorescent material mixtures. However, the UV radiation itself also finds application in the case of specific technical uses.

### BACKGROUND ART

Specification U.S. Pat. No. 5,604,410 describes a compact fluorescent lamp which is based on dielectrically impeded discharge, has a white light/fluorescent material mixture and is operated with a particularly efficient, pulsed operating method. In the interior of the cylindrical discharge vessel, there is, as the discharge medium, the noble gas xenon and, in addition, a rod-shaped metal electrode. Four strip-like electrodes are fitted to the outer side of the discharge vessel such that they are oriented parallel to the rod-shaped metal electrode. Disadvantages include, firstly, the damage due to sputtering which increases over the course of the lamp life on the inner metal electrode and the manufacturing complexity for the gas-tight metal bushing for the rod-shaped metal electrode. Secondly, there is the problem in the case of the outer electrodes of protection against electric shock and of unintentional damage, in particular when the screw base lamp is screwed into a luminaire. Another disadvantage is the high (dead) volume of the discharge vessel, since the filling gas xenon is relatively expensive.

Specification U.S. Pat. No. 2002/0163306 discloses a tubular barrier discharge lamp having linear inner electrodes. The inner electrodes covered by a glass layer extend along the entire inner wall of the discharge tube and are passed to the outside in a gas-tight manner at one end. For this purpose, the discharge tube is sealed in a gas-tight manner at the end of the electrode bushings with the aid a plate-like closure element. For this purpose, the discharge tube is provided at this end with a constriction which surrounds the edge of the plate-like closure element in the form of a ring. Then, the constriction and the plate-like closure element are sealed to one another in a gas-tight manner, the inner electrodes being passed to the outside through this seal. One disadvantage is the additional manufacturing complexity for the glass layer required on the inner electrodes as the dielectric barrier and for the gas-tight electrode bushing.

### DISCLOSURE OF THE INVENTION

The object of the present invention is to provide a dielectric barrier discharge lamp which is improved as regards the abovementioned disadvantages.

This object is achieved by a dielectric barrier discharge lamp having a discharge vessel and at least two electrodes, the discharge vessel comprises an outer bulb and an inner bulb, the inner bulb is arranged within the outer bulb, the inner bulb and the outer bulb are connected to one another in a gas-tight manner, with the result that a discharge space filled with a discharge medium is formed between the inner and the outer bulb, the electrodes are arranged on the outer side, which is remote from the discharge space, of the wall of the inner bulb.

In addition, protection is claimed for an illumination system having a dielectric barrier discharge lamp according to the invention and an electrical supply device.

The invention is based on the knowledge that, although on the one hand it is advantageous to implement a dielectric barrier discharge lamp having outer electrodes, owing to the simple production of the electrodes without a dielectric coating and with simple contact being made between the electrodes and an operating device, without it being necessary to accept the need for a gas-tight current bushing, on the other hand, the outer electrodes should also be protected against electric shock and possibly other external influences. The solution according to the invention, which combines these two aspects, provides, in simple terms, for the discharge vessel to be composed, in a gas-tight manner, of an outer bulb and a preferably tubular inner bulb arranged therein and having a smaller diameter, and for the electrodes to be arranged on the outer side of the discharge vessel wall but within the inner bulb. That is to say, the wall of the inner bulb spans a cavity, which likewise forms a type of turned-in section in the discharge vessel, in which the outer electrodes are located. In this manner, the outer electrodes are protected against unintentional access. Since the cavity is accessible at least from one or both end sides of the lamp, the preferably strip-like or linear electrodes can be fitted to the outer side, which is remote from the discharge space, of the inner bulb without any problems, preferably such that they are oriented parallel to the longitudinal axis of the inner bulb. The electrodes are preferably arranged such that they are evenly distributed with respect to the periphery of the inner bulb. In addition, the electrodes can be connected without any problems to an electrical supply device, which is preferably designed for the pulsed operation disclosed in U.S. Pat. No. 5,604,410, via suitable power supply lines, to be precise without a complex, gas-tight current bushing. During operation, numerous discharges are formed in the discharge space in the immediate vicinity of the inner side of the inner bulb, the individual discharges from one electrode being oriented with respect to the immediately adjacent electrode of another polarity. In this regard, this is similar to the situation described in U.S. Pat. No. 5,994,849 for flat radiators. Owing to this “extensive” discharge, the spacing from the opposite wall of the discharge vessel, i.e. from the outer bulb wall, is selected to be relatively small. This results in a further advantage of the special form of the discharge vessel, namely the considerable reduction, in comparison with a conventional, bulb-shaped vessel, in the required quantity of discharge medium, since only the space between the inner bulb and the outer bulb is filled with the discharge medium. That is to say, the turned-in section in the form of a cavity formed by the inner bulb does not contribute to the actual discharge vessel volume. Instead, this part is dispensed with compared to the entire volume enclosed by the outer bulb. This is even more so the case since the spacing between the wall of the inner bulb and the wall of the outer bulb is, at least in subsections of the discharge vessel, smaller or even considerably smaller than the inner diameter of the inner bulb, typically only a few millimeters.

In principle, various forms are suitable for the outer bulb, in particular even the pear shape known from incandescent lamps or a tubular design.

In the simplest case, the tubular inner bulb and the tubular outer bulb are of equal length. In this case, the inner bulb rests concentrically within the outer bulb and is connected to said outer bulb in a gas-tight manner at each of its two ends. In one variant, the tubular inner bulb is shorter than the tubular outer bulb at one end of the discharge vessel. There, the two bulbs are each sealed with a dome-like bowl. At the other end of the discharge vessel, the two bulbs are connected to one another in a gas-tight manner.

In the case of a pear-shaped outer bulb, the tubular inner bulb is sealed at one end with a dome-like bowl and is connected at its other end in a gas-tight manner to the pear-shaped outer bulb.

For applications in which not UV radiation but visible light is required, in particular for general lighting, the inner side of the discharge vessel wall is coated with a fluorescent material or fluorescent material mixture. In addition, the inner side of the wall of the inner bulb, optionally also the conical part in the case of a pear-shaped outer bulb, is preferably provided with a reflective layer, for example comprising Al₂O₃, TiO₂ or MgO. The reflective layer increases the useful luminous flux.

In addition, the lamp according to the invention may be provided, at least at one end, with a base, in the case of general lighting, for example with a conventional Edison screw base, which seals the cavity with the outer electrodes located therein. This has the advantage, inter alia, that in this case the outer electrodes are protected not only against electric shock but also against other external influences, for example moisture. In addition, the electronic ballast which is required for the preferred pulsed operation mentioned above can under certain circumstances be integrated in this base.

By way of summary, it may be stated that the concept according to the invention combines simple manufacture, namely by dispensing with inner electrodes having a dielectric coating and gas-tight current bushing, with protection of the outer electrodes, for example against electric shock.

### BRIEF DESCRIPTION OF THE DRAWINGS

The invention will be explained in more detail below with reference to exemplary embodiments. In the figures:

FIG. 1a shows a partial longitudinal section through a first exemplary embodiment of a dielectric barrier discharge lamp according to the invention having a cylindrical discharge vessel,

FIG. 1b shows a cross section through the lamp shown in FIG. 1a along the line AB,

FIG. 2 shows a partial longitudinal section through a second exemplary embodiment of a dielectric barrier discharge lamp according to the invention having a pear-shaped discharge vessel,

FIG. 3a shows a longitudinal section through a further exemplary embodiment of a dielectric barrier discharge lamp according to the invention, and

FIG. 3b shows a cross section through the lamp shown in FIG. 3a along the line AB.

### BEST MODE FOR CARRYING OUT THE INVENTION

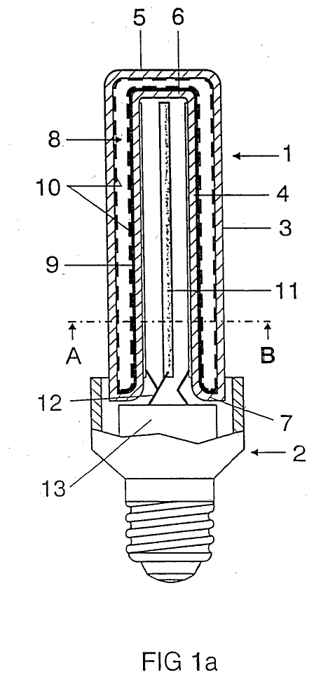

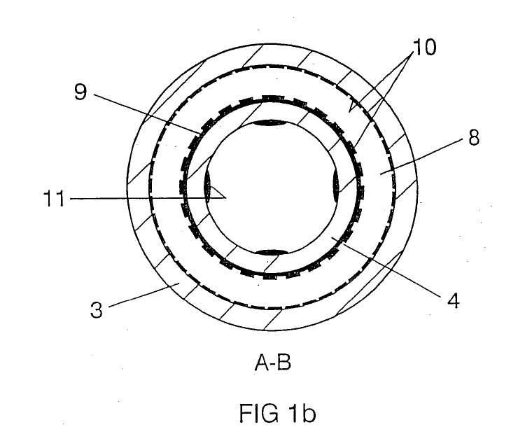

FIGS. 1a and 1b show a schematic illustration of a partial longitudinal section and a cross section along the line AB through a dielectric barrier discharge lamp according to the invention for general lighting. The lamp essentially comprises an elongate discharge vessel 1 made of glass and a screw base 2, which is mounted at one end of the discharge vessel 1. The discharge vessel 1 has a tubular outer bulb 3 and a likewise tubular inner bulb 4 which is arranged concentrically therein. At that end of the discharge vessel 1 which is remote from the base, the inner bulb 4 is shorter than the outer bulb 3. There, the two bulbs 3, 4 are each sealed with a dome-like bowl 5, 6. At the other end of the discharge vessel 1, the two bulbs 3, 4 are connected to one another in a gas-tight manner by means of a section 7 in the form of an annular plate. In this manner, a volume 8, which is in the form of an annular gap in cross section and is filled with 15 kPa of xenon and 35 kPa of neon as the discharge medium, is formed between the inner bulb 4 and the outer bulb 3. During operation of the lamp, in particular Xe₂* excimers, which emit a molecular band radiation having a maximum at approximately 172 nm, are produced within the discharge vessel 1. The outer diameter of the inner bulb 4 is approximately 1.0 cm, and the inner diameter of the outer bulb 3 is approximately 2.5 cm, i.e. the gap width is only 7.5 mm and, as a result, the discharge vessel volume or the gas volume required for the discharge medium is also relatively small. A reflective layer 9 comprising Al₂O₃ is applied to the inner side of the inner bulb 4, i.e. to the side which faces the discharge medium. A white light/fluorescent material mixture layer 10 is applied to this reflective layer 9 and to the rest of the inner side of the discharge vessel 1. This layer 10 converts the abovementioned Xe₂* excimer radiation into visible white light. Four strip-like electrodes 11a-11d having a width of 1.0 mm are fitted to the outer side of the inner bulb 4. The strip-like electrodes 11a-11d extend parallel to the longitudinal axis of the inner bulb 4 and essentially along the entire length of the inner bulb 4. In addition, the four electrodes 11a-11d are evenly distributed over the periphery of the inner bulb 4, i.e. are arranged at a constant mutual spacing. The electrodes 11a-11d are connected to an electronic ballast 13, which is integrated in the screw base 2, via power supply lines 12 in the form of wires. Alternatively, the ballast may also be integrated in the cavity surrounded by the outer side of the inner bulb (not shown). In each case, this dielectric barrier discharge lamp is suitable for use in conventional luminaires owing to the integrated ballast and the Edison screw base. The ballast 13 is designed for the pulsed operating method disclosed in the abovementioned U.S. Pat. No. 5,604,410. Further details on this can be found in U.S. Pat. No. 6,323,600.

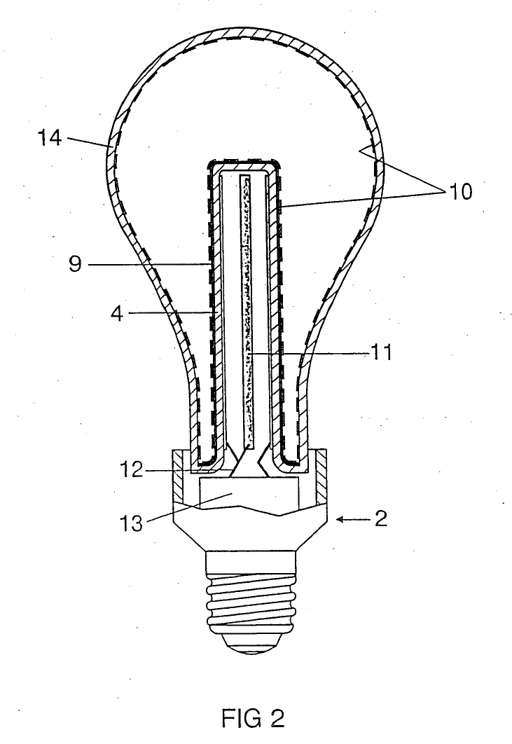

FIG. 2 shows a schematic of a partial longitudinal section through a second exemplary embodiment of a dielectric barrier discharge lamp according to the invention. This lamp-differs from the lamp illustrated in FIGS. 1a and 1b essentially by the pear-shaped outer bulb 14. In terms of appearance, this embodiment is thus similar to a conventional incandescent lamp. The same features as those in the lamp in FIGS. 1a and 1b are provided with the same reference numerals. The outer bulb 14 is connected in a gas-tight manner to the base-side end of the tubular inner bulb 4 on the side of the base 2 with the aid of a section 7 in the form of an annular plate. In one variant (not illustrated), in addition to the inner side of the inner bulb, the inner side of the conical part of the outer bulb is also provided with a reflective layer. As a result, the emitted light is directed in a conical manner.

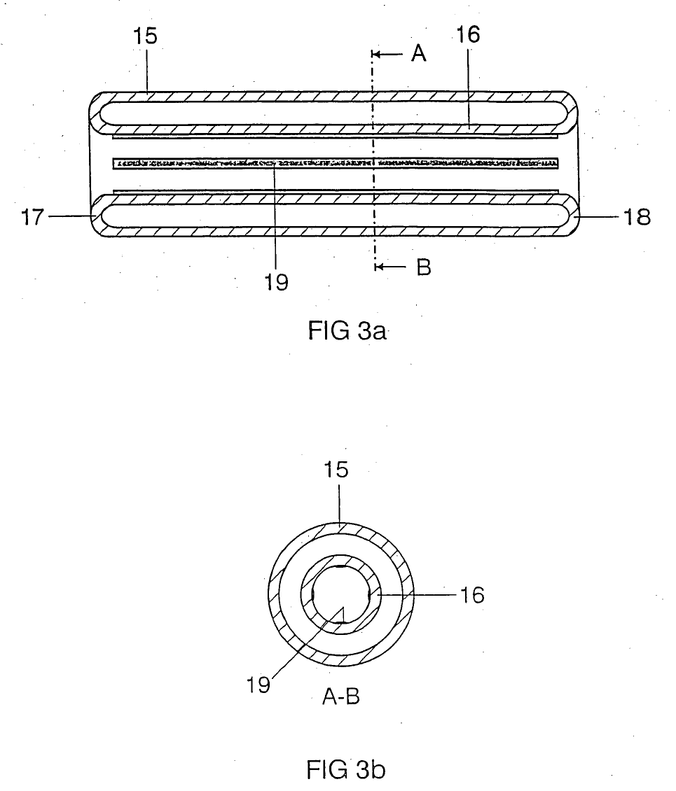

FIGS. 3a and 3b show a schematic illustration of a longitudinal section and a cross section along the line AB through a dielectric barrier discharge lamp according to the invention for UV irradiation. For this purpose, the lamp is likewise filled with xenon, but does not have a fluorescent material layer. The discharge vessel essentially comprises a tubular outer bulb 15 and a tubular inner bulb 16 arranged coaxially therein. The two bulbs 15, 16 are each connected to one another in a gas-tight manner at both ends by means of in each case an annular section 17, 18. Four strip-like electrodes 19 made of silver are fitted to the inner side of the inner bulb 16. The lamp may be installed, for example, in a luminaire or process chamber (not illustrated) which is provided specifically for this purpose, and in which there is also the power supply line for the electrodes.

1. A dielectric barrier discharge lamp having
a discharge vessel and at least two electrodes, the discharge vessel comprises an outer bulb and an inner bulb.
The inner bulb is arranged within the outer bulb,
The inner bulb and the outer bulb are connected to one another in a gas-tight manner, with the result that a discharge space filled with a discharge medium is formed between the inner and the outer bulb,
The electrodes are arranged on the outer side, which is remote from the discharge space, of the wall of the inner bulb.

2. The dielectric barrier discharge lamp as claimed in claim 1, the inner bulb having a tubular design

3. The dielectric barrier discharge lamp as claimed in claim 2, the outer bulb having a tubular design.

4. The dielectric barrier discharge lamp as claimed in claim 3, the tubular inner bulb and the tubular outer bulb being of equal length and being arranged concentrically with respect to one another, and the two bulbs being connected to one another at their two ends.

5. The dielectric barrier discharge lamp as claimed in claim 3, the tubular inner bulb being shorter than the tubular outer bulb at one end of the discharge vessel, the two bulbs each being sealed there with a dome-like bowl, and the two bulbs being connected to one another at the other end.

6. The dielectric barrier discharge lamp as claimed in claim 2, the outer bulb having a pear-shaped design.

7. The dielectric barrier discharge lamp as claimed in claim 6, the tubular inner bulb being sealed at one end with a dome-like bowl and being connected at its other end to the pear-shaped outer bulb.

8. The dielectric barrier discharge lamp as claimed in claim 1, the inner side of the discharge vessel wall being coated at least partially with fluorescent material.

9. The dielectric barrier discharge lamp as claimed in claim 1, the inner side at least of the wall of the inner bulb being provided with a reflective layer.

10. The dielectric barrier discharge lamp as claimed in claim 1, the discharge vessel being filled with xenon or with a xenon-containing gas mixture.

11. The dielectric barrier discharge lamp as claimed in claim 1, the spacing between the wall of the inner bulb and the wall of the outer bulb being, at least in subregions of the discharge vessel, smaller than the inner diameter of the inner bulb, typically a few millimeters, in particular less than approximately 10 millimeters.

12. The dielectric barrier discharge lamp as claimed in claim 1, the electrodes being in the form of a strip or line and being oriented parallel to the longitudinal axis of the inner bulb.

13. The dielectric barrier discharge lamp as claimed in claim 12, the electrodes being arranged such that they are evenly distributed with respect to the periphery of the inner bulb.

14. An illumination system having at least one dielectric barrier discharge lamp having the features according to claim 1 and an electrical supply device.

15. The illumination system as claimed in claim 14, the electrical supply device being arranged within the cavity which is defined by the outer side of the wall of the inner bulb.

16. The illumination system as claimed in claim 14, the dielectric barrier discharge lamp having a base, and the electrical supply device being integrated in the lamp base.

17. The dielectric barrier discharge lamp as claimed in claim 1, the outer bulb having a tubular design.

18. The dielectric barrier discharge lamp as claimed in claim 1, the outer bulb having a pear-shaped design.
